(19) United States
(12) Patent Application Publication
(10) Pub. No.: US 2006/0266791 A1
(43) Pub. Date: Nov. 30, 2006

(54) Work-table

(76) Inventors: Walter Koch, Schwanberg (AT); Stefan Lukas, St. Peter (AT)

Correspondence Address: WILLIAM COLLARD;COLLARD & ROE, P.C., 1077 NORTHERN BOULEVARD, ROSLYN, NY, 11576, US

(21) Appl. No.: 11/389,199

(22) Filed: Mar. 24, 2006

(30) Foreign Application Priority Data
Mar. 25, 2005 (AT) A 520/2005

(51) Int. Cl. B23K 1/06

(52) U.S. Cl. 228/1.1

(57) ABSTRACT

A work-table is described, comprising a frame (2) which is especially adjustable with respect to its height and for whose adjustment there is provided at least one electric motor (4) with a control device (6) acting upon an actuating drive (5). In order to provide advantageous constructional conditions it is proposed that at least one load-dissipating part (13) of the frame (2) is provided with a wire resistance strain gauge (12) or is supported on a force transducer (11), and that the wire resistance strain gauge (12) or the force transducer (11) triggers the control device (6) for the motor (4) depending on the loading of the load-dissipating part (13).

### 1. FIELD OF THE INVENTION

The invention relates to a work-table, comprising a frame which is especially adjustable with respect to its height and for whose adjustment there is provided at least one electric motor with a control device acting upon an actuating drive.

### 2. DESCRIPTION OF THE PRIOR ART

There is a likelihood in work-tables with a frame which can be adjusted in its height by at least one actuating drive driven by a motor that during the adjustment of the frame an obstruction in the path of the adjustment is hit, leading to an endangerment of the obstruction, as also the work-table or items situated on the work-table when the electromotor is not switched off. In order to detect such obstructions and thus avoid injuries it is known (AT 410 626 B) to connect the control device for the motor to a transducer for the motor load, so that upon exceeding a predetermined motor load the motor can be reversed in its direction of rotation by a control device and can be switched off after a thus induced return path. Since the motor load depends, among other things, on the frictional conditions in the region of the actuating drive and the guidance of the adjusting part of the table frame and these frictional conditions can change, a sensitive detection of the hit obstructions on the basis of a monitoring of the motor load is not possible.

### SUMMARY OF THE INVENTION

The invention is thus based on the object of configuring a work-table of the kind mentioned above with simple constructional means in such a way that obstructions in the path of movement of the work-table can be detected securely in a simple way before an impermissible force effect upon the obstruction by the work-table can be expected.

This object is achieved by the invention in such a way that at least one load-dissipating part of the frame is provided with a wire resistance strain gauge or is supported on a force transducer and that the wire resistance strain gauge or the force transducer triggers the control device for the motor depending on the loading of the load-dissipating part.

Since as a result of this measure the load of at least one load-dissipating part of the frame is detected directly by way of a wire resistance strain gauge or a force transducer, the respective table loads can be monitored with a comparatively high precision, irrespective of the respective frictional conditions in the guide area of the adjusting part of the frame or in the region of the actuating drive in order to intervene in the motor control in the case of a respective change of the load of the load-dissipating part and to enable the cut-off of the electric motor optionally after a reversal of the direction of rotation. In order to improve the monitoring of the load of the work-table or changes in load, two or more load-dissipating parts of the frame can be provided with measuring tape or be supported on force transducers, because the load conditions can be determined more precisely as a result of dividing the overall load of the work-table among the monitored load-dissipating parts.

When using wire resistance strain gauges, the load-dissipating part of the frame can be configured advantageously as a girder subject to bending. Such girders can be used advantageously for joining the actuating drive with the adjusting part of the frame. The load-dissipating part provided with the wire resistance strain gauge can also be loaded in the manner of a load cell by tension or pressure. Especially simple constructional conditions are obtained when force transducers are used on which the load-dissipating parts can be supported. Load-dissipating parts can be the table board for example or the frame itself when the frame is supported by way of respective force transducers on a foot part resting on a floor surface.

### BRIEF DESCRIPTION OF THE DRAWINGS

The subject matter of the invention is shown in the drawings by way of examples, wherein:

FIG. 1 shows a work-table in accordance with the invention in a schematic side view in the manner of a block diagram;

FIG. 2 shows the frame in a sectional view in the region of a length-adjustable table leg on an enlarged scale, and

FIG. 3 shows a constructional variant of a work-table in accordance with the invention in a schematic front view.

### DESCRIPTION OF THE PREFERRED EMBODIMENT

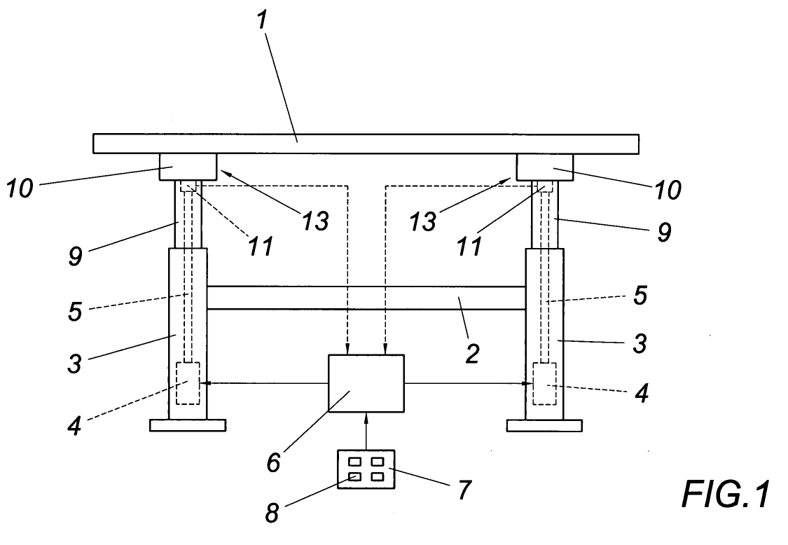

The work-table according to FIG. 1 comprises a table board 1 which is carried by a frame 2, comprising telescopic legs 3 for height adjustment of the table board 1. Said telescopic legs 3 are adjustable in their length with the help of electric motors 4. For this purpose the motors 4 each drive an actuating drive 5, e.g. a spindle drive or a toothed rack. A control device 6 is provided for controlling the motors 4, which control device can be triggered via an input unit 7 and forms a conventional entrance panel 8 for operating the work-table.

The supports 10 of table board 1 which are joined to the retractable adjusting part 9 of the telescopic legs 3 are supported via force transducers 11 on the actuating drives 5. The force transducers 11, e.g. load cells or piezoelectric elements, supply the control device 6 with signals which depend upon the loading of the table board 1, so that the motors 4 can be triggered depending on the loading of the table board 1 in order to determine any contact of the table board 1 with an obstruction, be that above or below the table board 1 and in order to enable the cut-off of the motors 4 depending on this, optionally after a reversal of the direction of rotation. Since generally one must expect different table loads, it is not the amount of the load that is evaluated, but the amount of the change in load for the control unit of motors 4 in order to recognize that an obstruction has been hit.

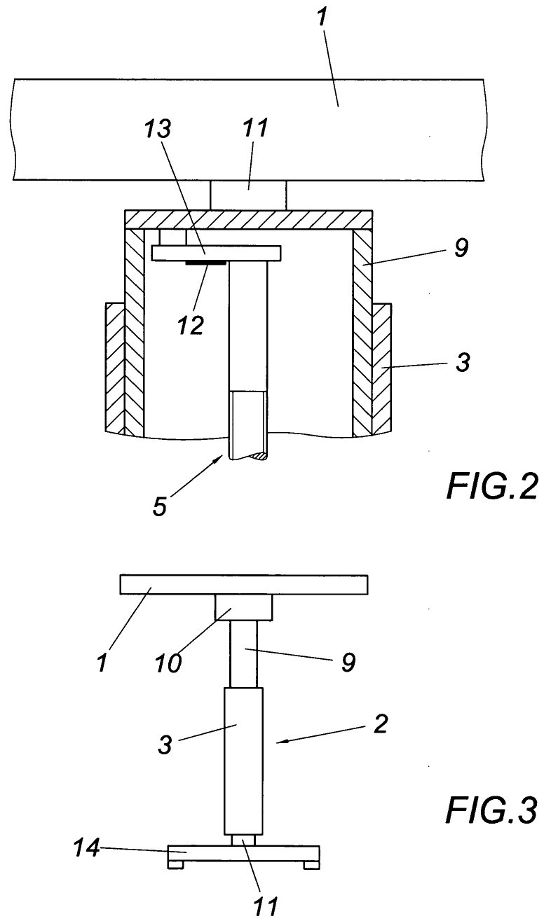

As is shown in FIG. 2, resistance wire strain gauges can be used for detecting the table load, which gauges are arranged on a load-dissipating part 13 of the frame 2. In the embodiment according to FIG. 2, the load-dissipating part 13 is not formed according to FIG. 1 by the supports 10 of the table board 1, but by a girder subject to bending, joining the actuating drive 5 with the adjusting part 9 of the telescopic legs 3. The changes in length of the wire resistance strain gauge 12 as caused by the bending strain of the load-dissipating part 13 can be used as a measure for the burden of part 13 and thus for the load of the table board 1 and can be used for controlling the motors 4.

FIG. 3 shows a further possibility for arranging force transducers 11, namely between the telescopic legs 3 and a foot part 14 of frame 2 resting on the floor space. Frame 2 is thus used as a load-dissipating part for determining the respective table load, which again allows a respective triggering of the motors 4 when hitting an obstruction.

It is fully understood that the invention is not limited to the illustrated embodiments, because it is merely relevant to provide a load-dissipating part of the work-table with a wire resistance strain gauge or to support the same on a force transducer. The evaluation of this monitoring of the table load can detect obstructions irrespective of whether they are located above or below the table board 1. Depending on the arrangement of the force transducers or the parts provided with the wire resistance strain gauges, an additional burdening or load alleviation indicates an obstruction on the upper or lower side of the table board.

1. A work-table, comprising a frame which is especially adjustable with respect to its height and for whose adjustment there is provided at least one electric motor with a control device acting upon an actuating drive, wherein at least one load-dissipating part (13) of the frame (2) is provided with a wire resistance strain gauge (12) or is supported on a force transducer (11), and that the wire resistance strain gauge (12) or the force transducer (11) triggers the control device (6) for the motor (4) depending on the loading of the load-dissipating part (13).

2. A work-table according to claim 1, wherein the load-dissipating part (13) provided with the wire resistance strain gauge (12) joins the actuating drive (5) with the adjusting part (9) of the frame (2).

3. A work-table according to claim 1, wherein the table board (1) or the frame (2) as a load-dissipating part is supported on at least one force transducer (11).
